(19) United States
(12) Patent Application Publication
(10) Pub. No.: US 2017/0363163 A1
(43) Pub. Date: Dec. 21, 2017

(54) SEQUENTIAL ELECTROMECHANICAL BRAKE WITH ADVANCED EMERGENCY TRIPPING

(71) Applicants: THYSSENKRUPP ELEVATOR AG, Essen (DE); thyssenkrupp AG, Essen (DE)

(72) Inventors: Jesús SANCHEZ CRIADO, Madrid (ES); Jose Manuel SANCHEZ ALVAREZ, Madrid (ES); Bernabé HERNANDEZ MONTEALEGRE, Madrid (ES)

(73) Assignees: THYSSENKRUPP ELEVATOR AG, Essen (DE); thyssenkrupp AG, Essen (DE)

(21) Appl. No.: 15/541,749

(22) PCT Filed: Jan. 9, 2015
(86) PCT No.: PCT/EP2015/050303

§ 371 Date: Jul. 6, 2017

(51) Int. Cl. F16D 65/18; B66B 29/00; F16D 55/30; F16D 65/12; B66B 5/02; B66B 1/32; F16D 127/12; F16D 65/02; F16D 121/14; F16D 121/22; F16D 127/00

(52) U.S. Cl. CPC F16D 65/18; B66B 5/02; B66B 29/00; F16D 55/30; F16D 65/121; F16D 65/125; F16D 65/127; B66B 1/32; F16D 2065/1328; F16D 2121/14; F16D 2121/22; F16D 2127/007; F16D 2127/12; F16D 2200/0008; F16D 2065/1312

(57) ABSTRACT

An electromechanical brake comprising mobile induced elements or sectors or frames (2), the number of mobile induced elements (2) or sectors being at least three, where one of the sectors acts faster than the rest, and where one of the sectors acts in a delayed manner with respect to the rest of the sectors in the case of an emergency, said time-delayed actuation being achieved by means of the antiparallel arrangement of a diode (6) on the coil (5) associated with said sector. Smooth and progressive stop is thus achieved in the case of an emergency.

### TECHNICAL FIELD

The object of the invention is a sequential electromechanical brake with advanced emergency tripping, i.e., a brake having a primary application in the field of elevators, not being limited to other applications, in which the brake is electromagnetically actuated and the actuation thereof occurs sequentially, as it is formed by different friction sectors or frames or devices, where it furthermore has the particularity of causing advanced tripping of one of the sectors in the case of an emergency and the stop occurs gradually.

The present invention is characterized by the special brake design, particularly of each of its sectors such that gradual braking is achieved, it being especially designed for emergency braking such that a fast actuation preventing the car from speeding up and at the same time allowing gradual and smooth braking is achieved.

Therefore, the present invention is comprised within of the field of electromechanical brakes preferably used in, but not limited to, the field of elevators.

### PRIOR ART

A conventional brake used in the sector has two braking sectors or devices as required by the standard indicating that braking means must be present in duplicate for safety reasons if one of them fails. Each of the sectors is capable of providing the rated torque or braking force necessary to be able to retain the entire car load.

The existence of patent EP2341261 in the state of the art is known, in which said patent proposes a brake device for elevators in which the mobile induced disc is constituted by a main disc part and by an auxiliary disc part, said parts are unequal in thickness and/or in configuration and/or in friction conditions of their guiding means as well as the different distance to the disc brake with respect to the front face of the main and auxiliary disc parts in the non-braking state and/or their different actuation speeds guarantee the non-simultaneity of actuation of each one of the disc parts, where each one on its own shall be capable of the sufficient braking effort to slow down the car moving with its rated load.

The proposal of patent EP 2341261 responds to a concept which suggests that the brake has an unequal structure in which, to change from the non-braking state to the braking state, the main and auxiliary disc parts will have to cover different distances at the same speed or the same distances at a different speed; which, In short, determines a sequential braking maneuver in which two successive impacts take place, although each of them is of much lesser intensity than when, as has occurred to date, a single impact takes place but of a much greater intensity. As has been proved, the non-simultaneity proposed herein results in a reduction of the noise level by ten percent, which is a considerable advantage; furthermore, that produced by the maneuver by means of two successive impacts of lesser intensity means that the effort to be supported by the splined shaft of the brake device is much smaller compared to the current situation of a single impact of much greater intensity.

In summary, the solution disclosed in said patent EP 2341261 seeks to reduce the noise level and to obtain a maneuver where the braking impacts are of lesser intensity.

Said brake however has drawbacks and aspects that are susceptible to improvement. On one hand, all the braking devices that they have are capable of stopping the car with its rated load, so in situations in which the car does not have the rated load, the stop occurs suddenly, the benefits of the sequentiality of the brake actuation not being appreciated. In other words, the braking system does not take the load of the car into account, the stop occurring in the same manner regardless of the load of the car.

Furthermore, as it is only formed by two parts, the braking impact remains high despite the sequentiality sought, said impact being susceptible to reduction.

Therefore, the object of the invention is to develop a brake that further smoothens the braking effect achieved up until now and has special application in emergency situations, developing an electromechanical disc such as that described below and the essential features of which are included in claim 1.

### Disclosure of the Invention

The object of the present invention is to develop a sequential electromechanical brake having advanced tripping in an emergency situation, i.e., a brake that seeks to achieve smooth and progressive actuation in the braking action particularly in emergency situations.

Emergency stops of an elevator can occur due to power cuts, door opening as a result of opening the safety means, etc. They are sudden stops caused by almost instantaneous actuation of the brake, unlike a normal stop in which the elevator is stopped progressively by electrical means.

The electromechanical brake object of the invention is divided into at least three friction sectors or frames or devices, where the braking torque of the assembly is twice the rated torque, the value doubling the rated torque being equally divided, preferably but in a non-limiting manner, between each sector.

The brake disc has a first sector, which is a fast actuating sector preventing the car from speeding up in the time interval that elapses between the control of the elevator sending the stop signal and the brake actuating thereon.

The faster actuation of the first sector is achieved by different means, among which, different frame or sector thickness, the presence of perforations allowing the passage of air through the perforations and therefore reaching the friction surface earlier through the sector having the perforations, the possibility of designing the brake with different air gap, or an increased spring pressure in the sector intended for performing faster actuation or a combination thereof, may be pointed out.

On the other hand, furthermore and for the faster sector and coil to physically contact one another, adhesive insulators keeping the frame and coil from contacting one another are incorporated.

Since double of the total rated torque of the brake disc has been divided between the different sectors, there being at least three sectors, the faster sector will never be able to stop the car.

The brake disc will also have a last sector, the terms first and last sectors being understood according to the time in which each sector actuates. This last sector is designed such that the actuation thereof is delayed with respect to the sector which had been actuated immediately before in time in order to achieve smooth and progressive stop in the case of an emergency stop.

The sectors comprised between the first sector and the last sector will act as a conventional braking device, not having any constructive particularity whatsoever, but are different from the first and last sector in that the actuation time is after the actuation time of the first sector and before the actuation time of the last sector.

Complementarily, the described brake can act with intensity and speed depending on the load in order to prevent sudden braking, not only in emergency situations.

Furthermore, the friction devices of the electromechanical brake can be selected individually or together depending on the load, where the selection of the friction devices involves not only which friction device or devices must act, but also the sequencing thereof.

Therefore, depending on the number of friction devices, which as indicated herein must be more than two, the actuation possibilities will be the result of the possible combinations that may arise. Therefore, by way of example, and if there were three friction devices:
One of them acts first, and then the remaining two act together.
One of them acts first, followed by the second one and subsequently the third one.
Two of them act first followed by the third one.

As a result of the described configuration, a sequential actuating electromechanical brake with progressive stop having special application in emergency stops is achieved, being especially useful in elevators without counterweight since they do not have a mass that counteracts the weight of the car and therefore the free fall thereof when an emergency stop of the elevator occurs.

In elevators without counterweight the problem of emergency stops doubles, on one hand such elevator speeds up more than a conventional elevator because it has no counterweight and, on the other hand, the brake must act progressively so that sudden braking does not occur (deceleration of less than 1 g that does not put passenger safety at risk).

Throughout the description and claims the word “comprises” and variants thereof do not seek to exclude other technical features, additions, components or steps. For the persons skilled in the art, other objects, advantages and features of the invention will be derived in part from the description and in part from the practice of the invention.

### DESCRIPTION OF THE DRAWINGS

To complement the description that is being made and for the purpose of aiding to better understand the features of the invention according to a preferred practical embodiment thereof, a set of drawings is attached as an integral part of said description in which the following is depicted with an illustrative and non-limiting character:

FIG. 1 shows an electromechanical brake object of the invention.

FIG. 2 shows the exploded view of the electromechanical brake where the elements forming part of the brake are shown.

FIG. 3 shows a depiction of a possible embodiment for the delayed actuation of the last sector.

### PREFERRED EMBODIMENT OF THE INVENTION

A preferred embodiment of the proposed invention is described below in view of the drawings.

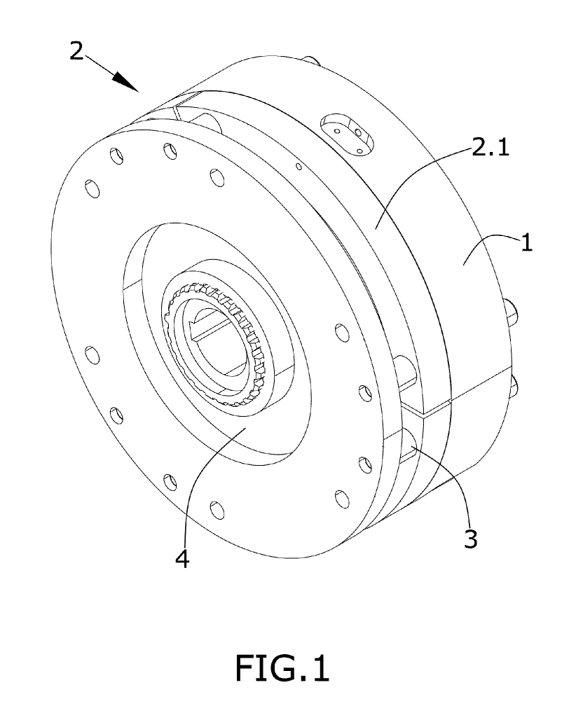

FIG. 1 shows that the electromechanical brake comprises a ferromagnetic disc (1), mobile induced elements or sectors or frames (2), guiding elements (3) and a brake disc (4).

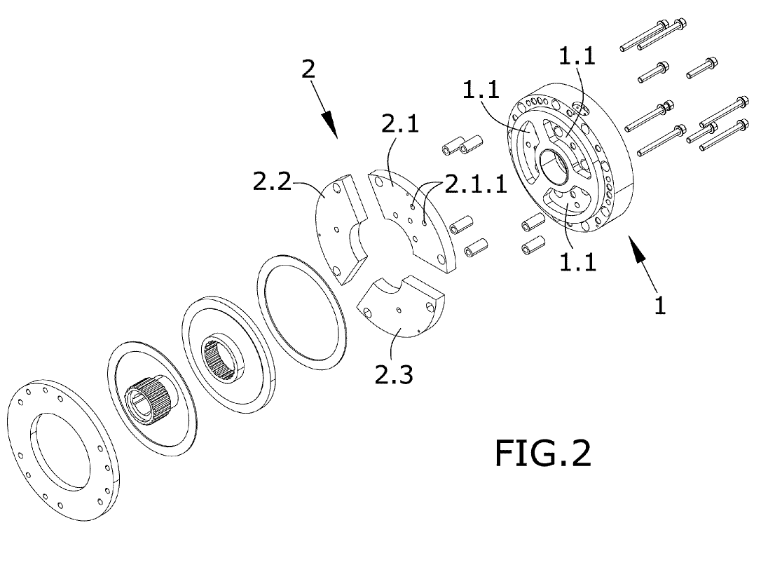

FIG. 2 shows how the mobile induced elements (2) comprise three friction devices (2.1), (2.2), (2.3), this being a possible embodiment, since one of the conditions is that the friction devices are more than two in number.

In a possible preferred but non-limiting embodiment, the friction devices (2.1), (2.2) and (2.3) are contained in one and the same plane, being able to adopt a circular ring shape together, so each of the friction devices corresponds to a circular ring sector, which do not need to be the same.

Furthermore, as a result of them being arranged on one and the same plane, the final size of the electromechanical brake is clearly smaller, favoring use thereof in smaller places.

On the other hand, the so-called ferromagnetic disc (1) has a series of kidney-shaped cavities (1.1) where coils (not depicted) for actuating on the friction devices (2.1) (2.2) and (2.3) would be housed. The shape of the cavities, and accordingly of the coils, entails better use of space, i.e., magnetization capacity with respect to a conventional square- or rectangular-shaped configuration is increased, having less amount of coils. This feature is also an additional factor contributing in, among other purposes, reducing the final volume of the electromechanical brake.

The embodiment shows a first sector (2.1) having a number of perforations (2.1.1) greater than the other two sectors (2.2) and (2.3) such that it will contact the brake disc (4) first after activating the signal for movement.

Given that the braking torque of the assembly must be twice the rated torque, in a possible embodiment, and if there are three sectors or frames, the three sectors can be equally divided such that each sector provides 2/3 of the rated torque.

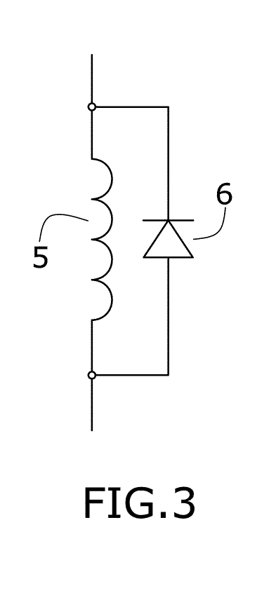

To achieve time-delayed actuation of a sector, which will be the so-called last sector, a possible embodiment is shown in FIG. 3, in which a diode (6) has been arranged antiparallel on the coil (5) associated with said sector in order to further allow current circulation through the coil and to thus produce a delay effect when the coil works as an electromagnet, causing an increase in demagnetization time, and accordingly, a delayed intervention of the sector with which it is associated.

Therefore, smooth and progressive stop can occur in the case of an emergency stop as a result of the sector assembly of the electromechanical brake having, in addition to a fast actuating sector, a last actuating sector actuating after the rest of the sectors.

In the elevator with an electromechanical brake such as the one described above in normal operation, i.e., without emergency stop, the diode to delay the actuation of the last sector does not act, the rest of the sectors acting simultaneously, except for the first sector, since progressive actuation is unnecessary since the car is stopped by electrical means.

Having sufficiently described the nature of the present invention as well as the manner of putting it into practice, it is hereby stated that within its essential features, it could be carried out to practice in other embodiments differing in detail from that indicated by way of example, and such embodiments would also be covered by the protection that is sought provided that the fundamental principle thereof is neither altered, changed nor modified.

1.-8. (canceled).

9. A sequential electromechanical brake with advanced emergency tripping comprising at least three mobile induced elements, sectors, or frames, wherein a first of the at least three mobile induced elements, sectors, or frames acts faster than a rest of the at least three mobile induced elements, sectors, or frames, wherein in an emergency a second of the at least three mobile induced elements, sectors, or frames acts in a delayed manner with respect to a rest of the at least three mobile induced elements, sectors, or frames.

10. The sequential electromechanical brake of claim 9 wherein the delayed manner with which the second of the at least three mobile induced elements, sectors, or frames acts is due to an antiparallel arrangement of a diode on a coil associated with the second of the at least three mobile induced elements, sectors, or frames.

11. The sequential electromechanical brake of claim 9 wherein a braking torque is twice a rated torque and is equally divided between the at least three mobile induced elements, sectors, or frames.

12. The sequential electromechanical brake of claim 9 wherein the at least three mobile induced elements, sectors, or frames actuate separately, wherein an actuating sequence of the at least three mobile induced elements, sectors, or frames depends on a load that the sequential electromechanical brake is braking.

13. The sequential electromechanical brake of claim 9 wherein two or more of the at least three mobile induced elements, sectors, or frames actuate together.

14. The sequential electromechanical brake of claim 13 wherein both an actuating sequence of the at least three mobile induced elements, sectors, or frames and a grouping of the two or more of the at least three mobile induced elements, sectors, or frames that actuate together depend on a load that the sequential electromechanical brake is braking.

15. The sequential electromechanical brake of claim 9 wherein faster actuation of the first of the at least three mobile induced elements, sectors, or frames is achieved by way of at least one of
a different thickness of the first of the at least three mobile induced elements, sectors, or frames;
perforations in the first of the at least three mobile induced elements, sectors, or frames that allow air to pass through the perforations and reach a surface of friction faster than the rest of the at least three mobile induced elements, sectors, or frames;
a brake design having a different air gap; or
an increased spring pressure in the first of the at least three mobile induced elements, sectors, or frames.

16. The sequential electromechanical brake of claim 9 configured to be installed in an elevator, an escalator, or a moving walkway.

17. The sequential electromechanical brake of claim 9 wherein each of the at least three mobile induced elements, sectors, or frames is a friction device, wherein the friction devices are disposed in a common plane.

18. The sequential electromechanical brake of claim 17 wherein the friction devices together form a circular ring shape.

19. The sequential electromechanical brake of claim 18 wherein the friction devices form unequal portions of the circular ring shape.

20. The sequential electromechanical brake of claim 9 further comprising a ferromagnetic disc.

21. The sequential electromechanical brake of claim 20 wherein each of the at least three mobile induced elements, sectors, or frames is a friction device, wherein the ferromagnetic disc includes cavities that receive coils for actuating the friction devices.

22. The sequential electromechanical brake of claim 21 further comprising a diode disposed antiparallel on one of the coils that is associated with the first of the at least three mobile induced elements, sectors, or frames.

23. The sequential electromechanical brake of claim 22 wherein the diode produces a delay effect in the one of the coils operating as an electromagnet, which delay effect causes an increase in a demagnetization time of the first of the at least three mobile induced elements, sectors, or frames.
